(19) United States
(12) Patent Application Publication
(10) Pub. No.: US 2008/0303798 A1
(43) Pub. Date: Dec. 11, 2008

(54) Display Device with Touch Panel

(76) Inventors: Noriharu Matsudate, Ooamishirasato (JP); Takeshi Ookawara, Mobara (JP); Norihiro Nakamura, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/134,286

(22) Filed: Jun. 6, 2008

(30) Foreign Application Priority Data
Jun. 6, 2007 (JP) 2007-149884

(51) Int. Cl. G06F 3/041

(52) U.S. Cl. 345/173

(57) ABSTRACT

Suggested is a display device with a touch panel which adopts a novel detection structure. The display device with the touch panel includes: a touch panel including a pair of substrates provided with electrodes on opposing surfaces thereof, and a spacer for retaining a gap between the pair of substrates; and a display panel located on a back surface of the touch panel, in which one of the pair of substrates is provided with a metal wiring formed on a resin.

### CROSS-REFERENCE TO RELATED APPLICATION

The present application claims priority from Japanese application JP2007-149884 filed on Jun. 6, 2007, the content of which is hereby incorporated by reference into this application.

### BACKGROUND OF THE INVENTION

1. Field of the Invention

The present invention relates to a display device with a touch panel, in particular, a coordinate detection structure of a touch panel.

2. Description of the Related Art

Major systems adopted by conventional touch panels include a system of detecting an optical change and a system of detecting a change in electric characteristic. Of those, the system of detecting an optical change presents a problem of instability in detection accuracy.

The system of detecting a change in electric characteristic is conventionally divided into a resistive film system and a capacity system.

FIG. 13 shows a conventional touch panel of a capacity system. The touch panel includes a transparent electrode TLINE that covers an entirety of a detection area on an inside surface of a glass substrate GSUB. In the touch panel, when the glass substrate GSUB is touched by a finger in a desired position from an outside thereof, a capacity generated between the finger and the transparent electrode TLINE is detected, to thereby recognize coordinates in which the finger has been placed on the glass substrate GSUB.

FIG. 14 shows a conventional touch panel of a resistive film system. The touch panel has a structure in which a transparent electrode TLINE that covers an entirety of a detection area is formed on a glass substrate GSUB, while on an opposite side thereto, another transparent electrode TLINE is formed on an optically transparent resin RESIN, and the two transparent electrodes TLINE, one of which is on the glass substrate GSUB, and the other one of which is on the optically transparent resin RESIN, are bonded to each other so as to face each other. In order to prevent the transparent electrodes TLINE from developing a short circuit, the structure is provided with transparent spacers SPACER between the surfaces to retain predetermined intervals (several μm to several tens of μm).

Systems prior to the resistive film system of FIG. 14 include such a system as disclosed in JP 2002-342014 A in which transparent electrodes are processed into stripe shapes, the stripe-shaped electrodes are located so as to intersect, and points of intersection are arranged in a matrix.

### SUMMARY OF THE INVENTION

In the above-mentioned system disclosed in JP 2002-342014 A, the stripe-shaped transparent electrodes are used, so there is no other way to improve a detection accuracy than to reduce a line width of the stripe-shaped transparent electrodes. However, since the transparent electrode having a small line width is high in resistance, a desired detection accuracy cannot be retained. In addition, since there is the need to consider a taper due to etching in a case where the transparent electrodes are formed to be thick, it is impossible to obtain a small gap.

Therefore, the resistive film system described above has made its appearance. In this system, since the transparent electrode is high in resistance, a potential difference between voltages applied to the transparent electrodes is used to one-dimensionally detect an input point, that is, a contact position between the upper and lower transparent electrodes, and to calculate two-dimensional coordinates thereof by applying a voltage thereto in X- and Y-axes and detecting a potential difference therebetween twice.

However, there arise the following problems.

A: Since this drive principle is obtained by applying a high resistance characteristic due to the transparent electrode being a metallic oxide, in a case of using a low resistance film, a voltage drop is reduced, to thereby make it impossible to perform the detection.

B: Since the transparent electrode is high in resistance, the size is hard to increase, and the practical size is considered to be 17 inches (approximately 200×300 mm) or smaller.

C: In order to detect two or more input points, a detection frequency needs to be at least doubled, which lowers the detection accuracy.

D: It takes much cost to pattern and form the transparent electrode.

E: The transparent electrode is of from 75% to 80% in transmittance due to the problem of an optical transmittance thereof.

F: The touch panel generally has a partial area used concentratedly, and particularly in a case of an input through a touch pen, a finger, or the like, its external force is concentrated on input coordinates. The external force causes the transparent electrode to warp about the input coordinates, which makes the transparent electrode susceptible to damage in the vicinity of the input coordinates.

G: Since the transparent electrode is generally a metallic oxide, deterioration of the electrode itself along with an increase in resistance is inevitable, which poses a problem with reliability in life.

H: The voltage drop needs to be detected in an analog manner, which raises the cost of circuits.

I: The cost of flexible cables for connecting the transparent electrodes and the circuits is high.

J: The transparent electrode has a resistance increased due to a flow of a current therethrough.

K: The transparent electrode is not actually transparent to bring about coloring, which subjects a display panel to deviation in color range.

In the light of the above-mentioned problems, the present invention has an object to suggest a display device with a touch panel which adopts a novel detection structure.

The present invention provides a plurality of aspects, of which representative aspects will be described below.

First, according to a first aspect, there is used a display device with a touch panel, including: a touch panel including a pair of substrates provided with electrodes on opposing surfaces thereof, and a spacer for retaining a gap between the pair of substrates; and a display panel located on a back surface of the touch panel, in which one of the pair of substrates is provided with a metal wiring formed on a resin.

According to the present invention, by bonding resin films provided with metal wirings through the intermediation of the spacer, a basic recognition structure can be realized, which makes it possible to manufacture an inexpensive touch panel that allows multipoint inputs and is high in durability.

Note that the present invention has been made because, in recent years, (1) the advancement of a cold rolling process technique for a metal material allows a metal foil to have a thickness of 5 to 10 μm, (2) the advancement of a fancy plywood technique allows the metal foil having the thickness of 5 to 10 μm to be bonded to a PET film or the like with high accuracy, and (3) the development of a wet etching technique in which a steep taper angle can be realized by ejecting an etchant at high temperature and high pressure allows the metal foil bonded to the PET film to realize a taper angle of almost 90°. Those techniques can realize such a vertical/horizontal dimension that allows the use as a touch panel.

Further, the one of substrates may be provided with a polarizing plate on an outside thereof. This can suppress ambient light reflection.

Further, the spacers may be provided in the gap. This allows the gap to be kept uniform. Further, a maximum width of a plan shape of the spacer viewed from a substrate thickness direction may be made larger than the pitch of the metal wiring. This can prevent a short circuit due to deformation of the resin film substrate from developing between the opposing metal wirings, thereby making it possible to suppress erroneous recognition of the touch panel.

Further, a maximum width of a plan shape of the spacer viewed from a substrate thickness direction may be made larger than the pitch of the metal wiring. This can reduce the fear of the short circuit.

Further, the width of the metal wiring may be set to less than 50% of the wiring pitch of the metal wiring. Unlike ITO, the metal wiring does not transmit light, resulting in reduction in transmittance, but the setting can prevent the reduction. Further, the wiring width may be set to 13 to 20 μm. This allows the use of an inexpensive emulsion photomask.

Further, the pitch of the metal wiring and a vertical or horizontal pitch of the display panel may be set to have a relationship of Table 1. This can suppress occurrence of moire.

TABLE 1

| VERTICAL OR HORIZONTAL | PITCH OF |
|---|---|
| PITCH P (μm) OF DISPLAY PANEL | METAL WIRING |
| P ≦ 100 | 3.15 mm OR LESS |
| 100 < P ≦ 120 | 2.63 mm OR LESS |
| 120 < P ≦ 140 | 2.23 mm OR LESS |
| 140 < P ≦ 170 | 1.81 mm OR LESS |
| 170 < P ≦ 200 | 1.51 mm OR LESS |
| 200 < P ≦ 250 | 1.17 mm OR LESS |
| 250 < P ≦ 300 | 0.95 mm OR LESS |
| 300 < P ≦ 350 | 0.79 mm OR LESS |
| 350 < P ≦ 400 | 0.67 mm OR LESS |
| 400 < P ≦ 500 | 0.51 mm OR LESS |
| 500 < P ≦ 700 | 0.39 mm OR LESS |
| 700 < P ≦ 1000 | 0.17 mm OR LESS |
| 1000 < P ≦ 1500 | 0.07 mm OR LESS |
| 1500 < P | 0.06 mm OR LESS |

### BRIEF DESCRIPTION OF THE DRAWINGS

In the accompanying drawings:

FIG. 1 is a plan schematic diagram of a touch panel according to an embodiment of the present invention;

FIG. 2 is a cross-sectional diagram of a display device with the touch panel according to the embodiment of the present invention;

FIG. 3 is an enlarged cross-sectional diagram of a second substrate SUB2 within the AA region of FIG. 1;

FIG. 4 is a perspective view of a touch panel according to a modified example;

FIG. 5 is a perspective view of a touch panel according to a modified example;

FIG. 6 is a plan schematic diagram of a touch panel according to a modified example;

FIG. 7 is a plan schematic diagram of a touch panel according to a modified example;

FIG. 8 is a cross-sectional diagram of a substrate constituting a touch panel according to a modified example;

FIG. 9 is a cross-sectional diagram of a substrate constituting a touch panel according to a modified example;

FIG. 10 is a cross-sectional diagram of a substrate constituting a touch panel according to a modified example;

FIG. 11 is a cross-sectional diagram of a substrate constituting a touch panel according to a modified example;

FIG. 12 is a diagram showing conditions for suppressing moire;

FIG. 13 is a principle diagram of a conventional capacity system; and

FIG. 14 is a principle diagram of a conventional resistive film system.

### DETAILED DESCRIPTION OF THE INVENTION

Hereinafter, description will be made of an embodiment of the present invention.

### [Wiring Layout Mode 1]

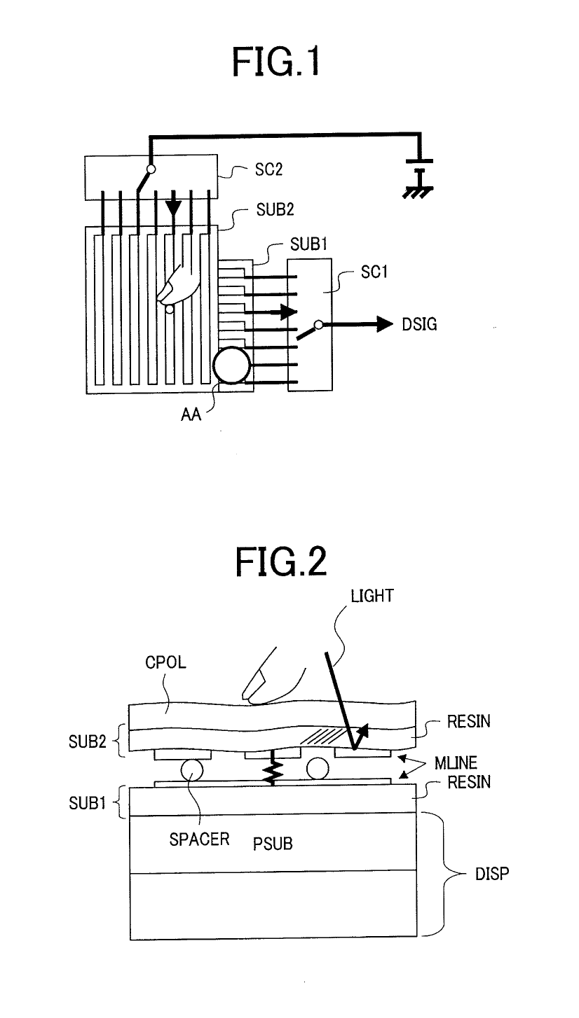

Shown as FIG. 1 is a plan schematic diagram of a touch panel according to this embodiment.

The touch panel according to this embodiment includes a first substrate SUB1 and a second substrate SUB2 that are resin films formed of PET, a first peripheral circuit SC1, a second peripheral circuit SC2, a power supply, and a detection signal output terminal.

The first substrate SUB1 and the second substrate SUB2 are flexible wiring substrates formed as follows. That is, a PET film and a copper foil having a film thickness reduced to 10 μm or less by cold rolling process are bonded to each other by using a fancy plywood technique. After that, by using an etching technique in which an etchant is ejected at high temperature and high pressure, the metal is processed into a stripe-shaped wiring having a taper angle of 80° to 90°. The first substrate SUB1 and the second substrate SUB2 are arranged so that their respective metal wirings face each other and that directions along which the respective metal wirings extend are made to intersect.

The second peripheral circuit SC2 is connected to the second substrate SUB2, and selects the metal wiring line by line to input a voltage thereto from the power supply.

The first peripheral circuit SC1 is connected to the first substrate SUB1, and selects the metal wiring line by line to detect a voltage therefrom.

Shown as FIG. 2 is a cross-sectional diagram of a display device with the touch panel of this embodiment. The cross-sectional diagram shows a state in which the touch panel of FIG. 1 is bonded to a surface of a display panel in further detail. The display device with the touch panel includes a display panel substrate PSUB composing a display device DISP, the first substrate SUB1, the second substrate SUB2, a spacer SPACER, and a circularly polarizing plate CPOL. The display panel substrate PSUB is made of non-alkali glass, constituting a display-surface-side substrate similar to a counter substrate of a liquid crystal display device and a sealing substrate of a top emission organic EL display device. The first substrate SUB1 is adhered onto the display panel substrate PSUB. The second substrate SUB2 is fixed to the first substrate SUB1 through the intermediation of the spacer SPACER by using a sealant (not shown), and is located above the display panel substrate PSUB. The first substrate SUB1 is fixed onto the display panel substrate PSUB. The circularly polarizing plate CPOL is fixed onto the second substrate SUB2.

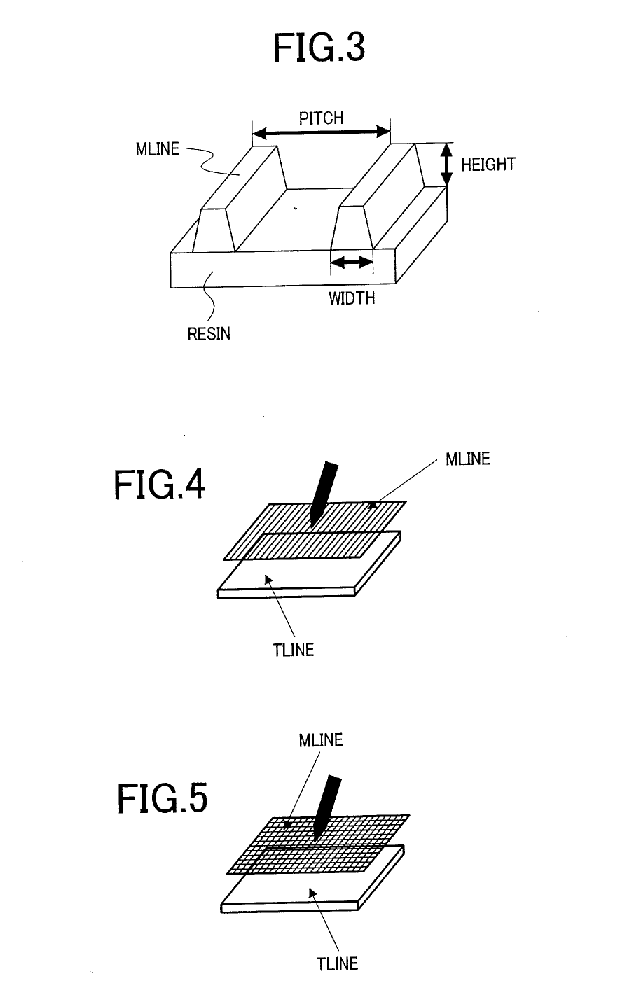

Shown as FIG. 3 is an enlarged cross-sectional diagram of the second substrate SUB2 within the AA region of FIG. 1. As described above, metal wirings MLINE are arranged on polyethylene terephthalate (PET). Table 2 shows prototype specifications of the metal wirings MLINE containing a wiring pitch PITCH, a wiring width WIDTH, a wiring height HEIGHT, a spacer height, and a resin substrate thickness.

TABLE 2

| | | | | | | RESIN | |
|---|---|---|---|---|---|---|---|
| | WIRING | | WIRING | WIRING | SPACER | SUBSTRATE | |
| | PITCH | | WIDTH | HEIGHT | HEIGHT | THICKNESS | |
| A | 120 | μm | 10 μm | 10 μm | 15 μm | 35 | μm |
| B | 80 | μm | 10 μm | 10 μm | 15 μm | 35 | μm |
| C | 120 | μm | 10 μm | 10 μm | 15 μm | 100 | μm |
| D | 80 | μm | 10 μm | 10 μm | 15 μm | 100 | μm |
| E | 120 | μm | 10 μm | 10 μm | 15 μm | 180 | μm |
| F | 80 | μm | 10 μm | 10 μm | 15 μm | 180 | μm |
| G | 120 | μm | 10 μm | 10 μm | 30 μm | 35 | μm |
| H | 80 | μm | 10 μm | 10 μm | 30 μm | 35 | μm |
| I | 120 | μm | 10 μm | 10 μm | 30 μm | 100 | μm |
| J | 80 | μm | 10 μm | 10 μm | 30 μm | 100 | μm |
| K | 120 | μm | 10 μm | 10 μm | 30 μm | 180 | μm |
| L | 80 | μm | 10 μm | 10 μm | 30 μm | 180 | μm |

The metal wirings MLINE can be manufactured appropriately with the wiring pitch PITCH of 80 to 1000 μm, the wiring width WIDTH of 8 to 50 μm, the wiring height HEIGHT of 10 to 150 μm, the spacer height of 5 to 50 μm, and the resin substrate thickness of 35 to 300 μm.

That is, in this embodiment, the display device with the touch panel includes: a touch panel including a pair of substrates provided with electrodes on their opposing surfaces and a spacer for retaining a gap between the pair of substrates; and a display panel located on aback surface of the touch panel, and in the display device with the touch panel, one of the pair of substrates is provided with a metal wiring formed on a resin.

According to this embodiment, by thus bonding resin films provided with metal wirings through the intermediation of the spacer, a basic recognition structure can be realized, which makes it possible to manufacture an inexpensive touch panel that allows high-speed multipoint inputs and is high in durability.

Further, a bright display can be realized by reducing the width of the metal wiring into less than 50% of the wiring pitch of the metal wiring.

Further, since one of the pair of the substrates is provided with a polarizing plate on an outside thereof, it is possible to suppress ambient light reflection.

Further, the spacers are provided in the gap, to thereby allow the gap to be uniform, and a maximum width of a plan shape of the spacer viewed from a substrate thickness direction is made larger than the pitch of the metal wiring, so a short circuit due to deformation of the resin film substrate can be prevented from developing between the opposing metal wirings, and it is possible to suppress erroneous recognition of the touch panel.

Further, a maximum width of a plan shape of the spacer viewed from a substrate thickness direction is made larger than the pitch of the metal wiring, so the fear of the short circuit can be reduced.

Further, unlike ITO, the metal wiring does not transmit light, so the width of the metal wiring is set to less than 50% of the wiring pitch of the metal wiring. This can prevent reduction in transmittance. If the wiring width is set to 13 to 20 μm, an inexpensive emulsion photomask becomes usable.

Further, by setting the pitch of the metal wiring and a vertical or horizontal pitch between adjacent pixels of the display panel, having the same color, to have a relationship of Table 1, it is possible to suppress occurrence of moire.

Possible materials of the metal wiring include an opaque metal film made of aluminum (Al), carbon (C), nonferrous metal such as copper (Cu), stainless steel (SUS), or iron (Fe).

As the resin of the first substrate SUB1 and the second substrate SUB2, not only PET but also triacetyl cellulose (TAC) can be applied. Another material may be used as long as the film is low in birefringence such as the above-mentioned materials.

According to this embodiment, a fine metal wiring pattern can achieve a definition of 300 line per inch (lpi), which can improve a resolution from approximately 10 point per inch (ppi) according to a conventional example into 10 times or more. In addition, the fine metal wiring pattern can be manufactured to have a width of 10 μm and a thickness of approximately 10 μm. Therefore, by such a design as to have a resolution of approximately 100 lpi, it is possible to further improve the transmittance than that of the conventional touch panel of the resistive film system.

Note that without concern for the cost issue, the metal wiring can be manufactured not only by etching but also by precipitation, plating, and the like.

The effects of using this embodiment are as described as follows.

(1) The metal wiring subjected to addressing is used, which allows a plurality of points to be detected simultaneously.

(2) The above-mentioned item allows the detection by a digital circuit, which makes it possible to reduce the cost.

(3) The transparent electrode does not need to be patterned, which makes it possible to reduce the cost.

(4) Further, the patterns of the metal wiring and a flexible cable can be formed simultaneously, which makes it possible to reduce the cost and improve the reliability.

(5) Since the metal wiring is low in resistance, a size of 40 inches or more becomes possible (diagonally 1 M or more), an application expands to an area in which the touch panel has been hard to mount.

(6) It is sufficiently possible for the metal wiring to have a definition of 300 lpi or more, which allows 10 times or more as high a resolution as a current resolution of approximately 10 ppi.

(7) By using the above-mentioned high resolution and a function of detecting a plurality of points simultaneously, it is possible to distinguish a difference in object or method for an input with respect to the touch panel, for example, a difference between a stylus such as a touch pen and a finger, based on a difference in the number of detected points.

(8) By changing the color of the above-mentioned metal wiring into black, it is possible to raise a contrast of a display such as a liquid crystal equipped with a touch panel.

(9) The coordinate detection is performed on the metal wiring (10 μm in thickness), so the reliability in life such as a detection count is improved into 10 times or more as high as the conventional transparent electrode (several hundred nm in thickness).

(10) The metal wiring is low in resistance, and detection can be performed digitally, which makes it possible to obtain a detection speed that is about 100 times or more as high speed and high accuracy as a conventional analog detection mechanism of the resistive film system.

### [Wiring Layout Mode 2]

Shown as FIG. 4 is a perspective view of a touch panel according to a modified example of this embodiment.

Wiring Layout Mode 2 of this embodiment is a modified example of Wiring Layout Mode 1, in which opposing wirings for detection are changed in structure.

FIG. 4 is different from FIG. 1 in that a transparent electrode made of ITO is used as the wiring arranged on the first substrate SUB1, and the ITO covers an entirety of a detection area.

By using this mode, it is possible to improve the reliability and detection speed, and realize a simple multipoint detection mechanism.

### [Wiring Layout Mode 3]

Shown as FIG. 5 is a perspective view of a touch panel according to a modified example of this embodiment.

Wiring Layout Mode 3 of this embodiment is a modified example of Wiring Layout Mode 1, in which opposing wirings for detection are changed in structure.

FIG. 5 is different from FIG. 4 in that the wiring arranged on the second substrate SUB2 forms a mesh.

By forming the metal wiring pattern as a mesh (lattice), the touch panel can be formed as a substitute of the resistive film, which can mainly contribute to the improvement of the detection speed and reliability. In addition, by using two-dimensional patterning, the multipoint detection mechanism can be realized with high speed and high accuracy even in combination with a conventional transparent electrode system.

Further, without concern for the cost, a system for overcoating a fine metal pattern section with a transparent electrode is effective in upsizing.

### [Wiring Layout Mode 4]

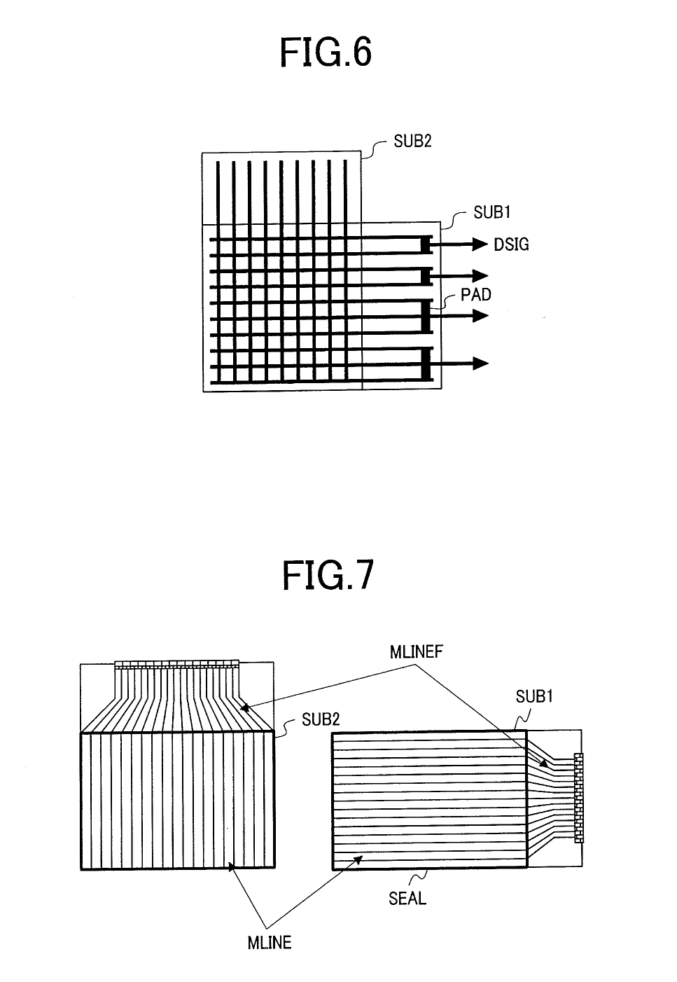

Shown as FIG. 6 is a plan schematic diagram of a touch panel according to a modified example of this embodiment.

FIG. 6 is different from FIG. 1 in that a terminal PAD for combining a plurality of metal wirings MLINE is provided in order to detect voltages of the plurality of metal wirings MLINE simultaneously, and a detection signal is output from each terminal PAD.

If the coordinate detection high in definition is unnecessary, the plurality of metal wirings MLINE are combined, to thereby enhance a recognition rate.

This mode can be applied to the stripe-shaped metal wirings according to Wiring Layout Modes 1 and 2.

### [Wiring Layout Mode 5]

Shown as FIG. 7 is a plan schematic diagram of a touch panel according to a modified example of this embodiment.

FIG. 7 is different from FIG. 1 in that the plurality of metal wirings MLINE are made to extend up to external terminals on the resins while decreasing the wiring pitch outside the detection area. In other words, the external terminals and wirings MLINEF extending up to the external terminals are each formed not on another substrate but on the same base film on which the plurality of metal wirings MLINE are formed.

This mode can be applied to the stripe-shaped metal wirings according to Wiring Layout Modes 1 to 4.

Accordingly, by adopting Wiring Layout Modes 1 to 4, it is possible to simultaneously form a metal pattern and a flexible cable pattern for connection to a circuit. A touch panel section and flexible cables are formed on a unitarily continuous resin, thereby making it possible to reduce the number of parts, improve the reliability in connection, and lower the cost.

### [Wiring Layout Mode 6]

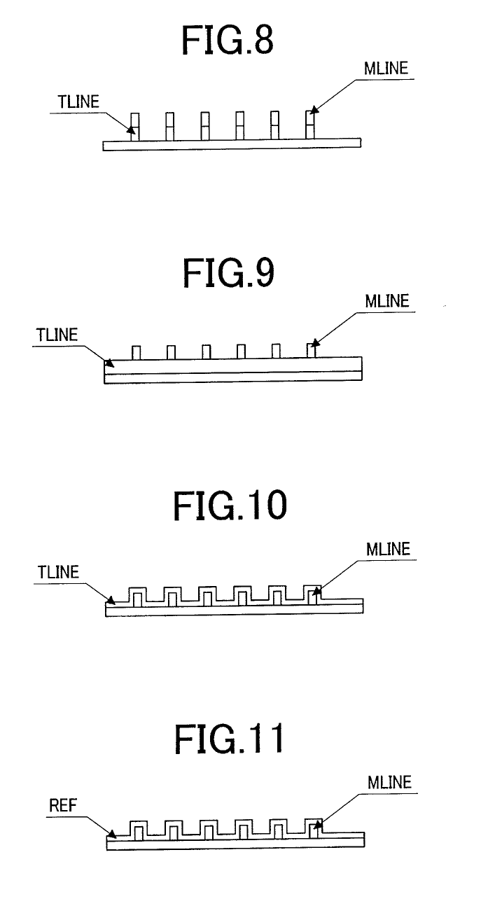

Shown as FIG. 8 is a cross-sectional diagram of a substrate constituting a touch panel according to a modified example of this embodiment.

FIG. 8 is different from FIG. 3 in that a stripe-shaped transparent wiring TLINE having the same pattern as that of the metal wiring MLINE is located under the metal wiring MLINE.

This mode can be applied to the stripe-shaped metal wirings according to Wiring Layout Modes 1 to 5.

### [Wiring Layout Mode 7]

Shown as FIG. 9 is a cross-sectional diagram of a substrate constituting a touch panel according to a modified example of this embodiment.

FIG. 9 is different from FIG. 3 in that a transparent wiring (electrode) TLINE that covers the entirety of the detection area is located under the metal wiring MLINE.

This mode can be applied to the stripe-shaped metal wirings according to Wiring Layout Modes 1 to 5.

### [Wiring Layout Mode 8]

Shown as FIG. 10 is a cross-sectional diagram of a substrate constituting a touch panel according to a modified example of this embodiment.

FIG. 10 is different from FIG. 3 in that a transparent wiring (electrode) TLINE that covers the entirety of the detection area is located above the metal wiring MLINE.

This mode can be applied to the stripe-shaped metal wirings according to Wiring Layout Modes 1 to 5.

### [Wiring Layout Mode 9]

Shown as FIG. 11 is a cross-sectional diagram of a substrate constituting a touch panel according to a modified example of this embodiment.

FIG. 11 is different from FIG. 3 in that an inner surface reflection preventive film REF made of an SiO₂ thin film that covers the entirety of the detection area is located above the metal wiring MLINE.

This mode can be applied to the stripe-shaped metal wirings according to Wiring Layout Modes 1 to 5.

Further, a conventional touch panel, which includes a transparent electrode, is high in cost. According to this embodiment, since the inner surface reflection preventive film can be manufactured at low cost, high display quality is made compatible with low cost.

[Measure Against Moire in a Case where this Embodiment is Applied to the Display Panel with the Touch Panel]

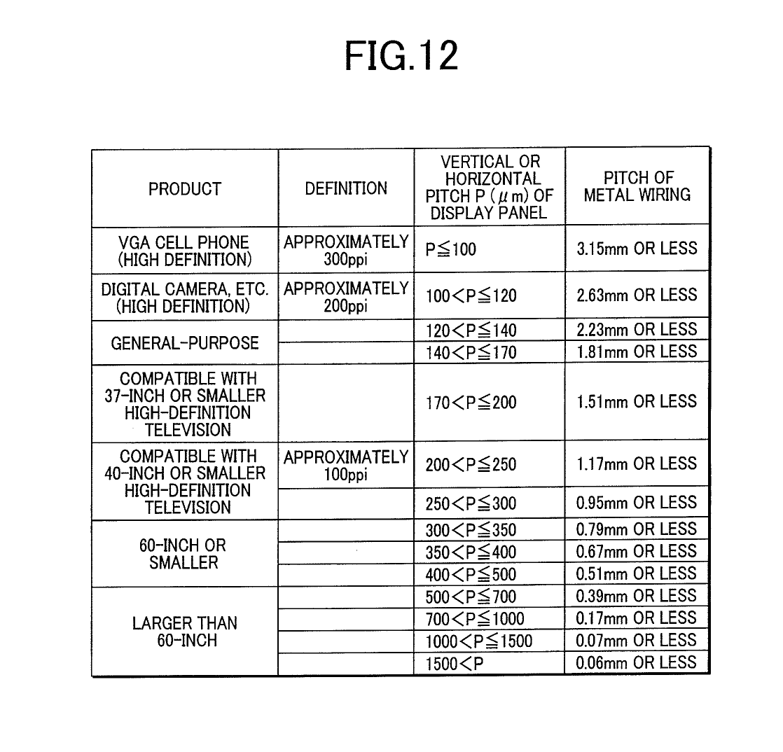

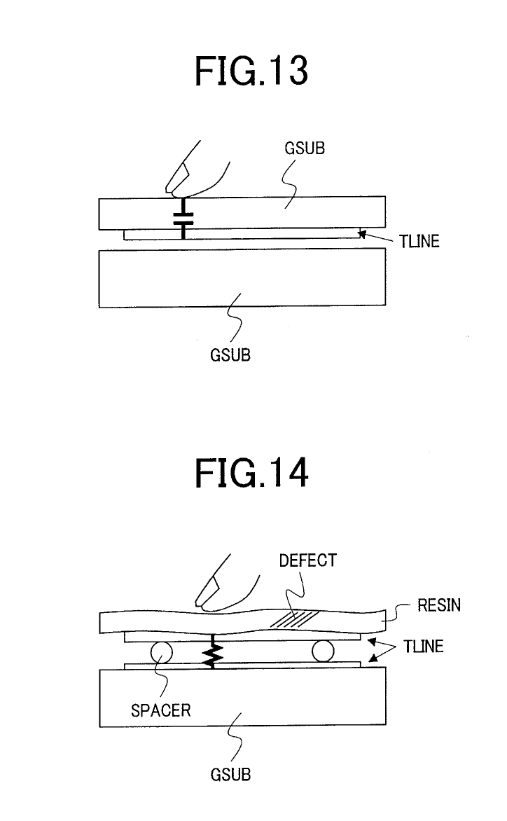

In a case where the metal wiring is used as a wiring for the coordinate detection as in Wiring Layout Modes 1 to 9, conditions for suppressing moire to such an extent as to be unrecognizable are shown in FIG. 12.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A display device with a touch panel, comprising:
a touch panel including:
a pair of substrates provided with electrodes on opposing surfaces thereof; and
a spacer for retaining a gap between the pair of substrates; and
a display panel located on a back surface of the touch panel,
wherein one of the pair of substrates is provided with a metal wiring formed on a resin.

2. A display device with a touch panel, according to claim 1, wherein another one of the pair of substrates is provided with a metal wiring formed on a resin.

3. A display device with a touch panel, according to claim 1, wherein the one of the pair of substrates is provided with a polarizing plate on an outside thereof.

4. A display device with a touch panel, according to claim 1, wherein a maximum width of a plan shape of the spacer viewed from a substrate thickness direction is made larger than a pitch of the metal wiring.

5. A display device with a touch panel, according to claim 1, wherein a width of the metal wiring is set to less than 50% of a wiring pitch of the metal wiring.

6. A display device with a touch panel, according to claim 4, wherein the pitch of the metal wiring is set to 3.15 mm or less when one of a vertical pitch and a horizontal pitch between pixels of the display panel is set to 100 μm or less.

7. A display device with a touch panel, according to claim 4, wherein the pitch of the metal wiring is set to 2.63 mm or less when one of a vertical pitch and a horizontal pitch between pixels of the display panel is set to more than 100 μm and equal to or less than 120 μm.

8. A display device with a touch panel, according to claim 4, wherein the pitch of the metal wiring is set to 2.23 mm or less when one of a vertical pitch and a horizontal pitch between pixels of the display panel is set to more than 120 μm and equal to or less than 140 μm.

9. A display device with a touch panel, according to claim 4, wherein the pitch of the metal wiring is set to 1.81 mm or less when one of a vertical pitch and a horizontal pitch between pixels of the display panel is set to more than 140 μm and equal to or less than 170 μm.

10. A display device with a touch panel, according to claim 5, wherein the wiring pitch of the metal wiring is set to 3.15 mm or less when one of a vertical pitch and a horizontal pitch between pixels of the display panel is set to 100 μm or less.

11. A display device with a touch panel, according to claim 5, wherein the wiring pitch of the metal wiring is set to 2.63 mm or less when one of a vertical pitch and a horizontal pitch between pixels of the display panel is set to more than 100 μm and equal to or less than 120 μm.

12. A display device with a touch panel, according to claim 5, wherein the wiring pitch of the metal wiring is set to 2.23 mm or less when one of a vertical pitch and a horizontal pitch between pixels of the display panel is set to more than 120 μm and equal to or less than 140 μm.

13. A display device with a touch panel, according to claim 5, wherein the wiring pitch of the metal wiring is set to 1.81 mm or less when one of a vertical pitch and a horizontal pitch between pixels of the display panel is set to more than 140 μm and equal to or less than 170 μm.

14. A display device with a touch panel, according to claim 5, wherein the width of the metal wiring is smaller than a width of an interval between the metal wirings.

15. A display device with a touch panel, according to claim 5, wherein an area occupied by the metal wiring within a detection area is smaller than an area between the metal wirings.
